(19) United States
(12) Patent Application Publication
(10) Pub. No.: US 2007/0064243 A1
(43) Pub. Date: Mar. 22, 2007

(54) Method of characterizing substrate warpage

(76) Inventors: Yusri Mohamed Yunus, Selangor (MY); Kok Wai Mui, Selangor (MY)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/230,595

(22) Filed: Sep. 20, 2005

(51) Int. Cl. G01B 11/24

(52) U.S. Cl. 356/601; 356/237.4

(57) ABSTRACT

A method of characterizing warpage of a ball grid array (BGA) substrate having solder balls attached to its surface includes scanning each corner and a central portion of the substrate to obtain scanned data and measuring respective coplanarities of the solder balls in the central portion and each corner of the substrate. Average coplanarities for the central portion and each corner are calculated and differences between the average coplanarity of the central portion and the average coplanarities for each corner are calculated to determine a warpage characteristic for each corner of the substrate. A curvature profile based on the warpage characteristic of each corner is generated and pass/fail of the substrate can be determined based on the generated curvature profile.

### BACKGROUND OF THE INVENTION

The present invention relates to warpage characterization in general and more specifically to a method of characterizing warpage of a substrate.

Warpage of substrates in semiconductor devices is known to cause significant production and reliability problems such as, damaged and misregistered components, solder paste bridging and opens, cracked solder joints, and production line jams. Warpage characterization is therefore used in pre-production applications to qualify each substrate for assembly, and also as part of production diagnostics. At present, a single measured warpage value is used as a basis for accepting or rejecting a substrate.

Usually, one of four curvature profiles, illustrated in FIGS. 1A through 1D, is assigned to the substrate when reporting device warpage. FIG. 1A is an enlarged cross-sectional view of a substrate 10 having concave warpage, FIG. 1B is an enlarged cross-sectional view of a substrate 12 having m-profile warpage, FIG. 1C is an enlarged cross-sectional view of a substrate 14 having convex warpage, while FIG. 1D is an enlarged cross-sectional view of a substrate 16 having w-profile warpage. The substrates 10, 12, 14 and 16 are shown with solder balls 18 attached to a surface thereof. However, because there are numerous possible curvature profiles, current methods of warpage characterization do not accurately define the curvature profile of a substrate. Hence, it is difficult to use current warpage characterization methods to segregate substrates or screen out undesirable substrates based on their curvature profiles. In view of the foregoing, there exists a need for a method of accurately characterizing warpage of a substrate.

Accordingly, it is an object of the present invention to provide a method of accurately characterizing warpage of a substrate and using a determined warpage to assess the usability of the substrate.

### BRIEF DESCRIPTION OF THE DRAWINGS

The following detailed description of preferred embodiments of the invention will be better understood when read in conjunction with the appended drawings. The present invention is illustrated by way of example and is not limited by the accompanying figures, in which like references indicate similar elements. It is to be understood that the drawings are not to scale and have been simplified for ease of understanding the invention.

FIGS. 1A-1D are enlarged cross-sectional views of substrate curvature profiles;

FIG. 2 is an enlarged top plan view of a ball grid array (BGA) substrate having a plurality of solder balls;

FIG. 3 is an enlarged cross-sectional view of a solder ball of the substrate of FIG. 2 illustrating the measurement of the coplanarity of a solder ball in accordance with an embodiment of the present invention;

FIGS. 4A and 4B are illustrations of top plan views of BGA substrates including coplanarity measurements of a plurality of locations on the substrates in accordance with an embodiment of the present invention; and

FIGS. 5A-5D are perspective views of exemplary curvature profiles stored in a library of predetermined curvature profiles in accordance with an embodiment of the present invention.

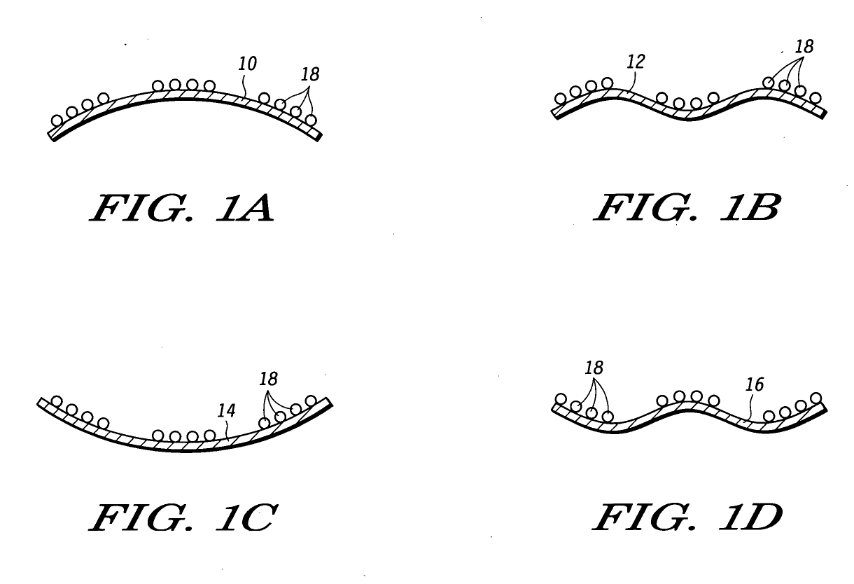

### DETAILED DESCRIPTION OF THE PREFERRED EMBODIMENTS

The detailed description set forth below in connection with the appended drawings is intended as a description of the presently preferred embodiments of the invention, and is not intended to represent the only form in which the present invention may be practiced. It is to be understood that the same or equivalent functions may be accomplished by different embodiments that are intended to be encompassed within the spirit and scope of the invention.

To achieve the objects and advantages discussed above and others, the present invention provides a method of characterizing warpage of a substrate including the steps of scanning a plurality of predetermined locations on the substrate to obtain substrate scanned data and calculating a warpage characteristic of the substrate using the scanned data. Then, a curvature profile is generated based on the calculated warpage characteristic.

The present invention also provides a method of characterizing warpage of a substrate including the steps of scanning at least each corner and a central portion of the substrate to obtain substrate scanned data and calculating a warpage characteristic for each corner of the substrate relative to the central portion using the scanned data. Then, a curvature profile is generated based on the warpage characteristic of each corner of the substrate.

The present invention further provides a method of characterizing warpage of a ball grid array (BGA) substrate having a plurality of solder balls attached to a surface thereof. The method includes the steps of scanning at least each corner and a central portion of the BGA substrate to obtain a plurality of data on the BGA substrate and measuring respective coplanarities of the solder balls in the central portion and each corner of the BGA substrate. Respective average coplanarities for the central portion and each corner of the BGA substrate are calculated and a difference between the average coplanarity of the central portion and the respective average coplanarities for each corner is calculated to determine a warpage characteristic for each corner of the BGA substrate. Then, a curvature profile based on the warpage characteristic of each corner of the BGA substrate is generated. A pass/fail of the substrate is determined based on the generated curvature profile.

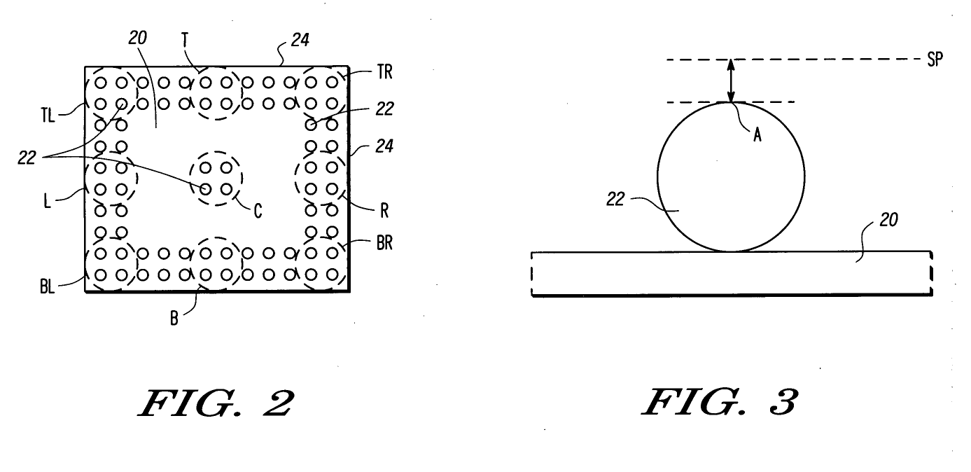

Referring now to FIG. 2, an enlarged top plan view of a ball grid array (BGA) substrate 20 having a plurality of solder balls 22 attached to a surface thereof is shown. A plurality of predetermined locations on the substrate 20 is scanned to obtain substrate scanned data. In this particular example, the plurality of predetermined locations includes the four corners denoted as TL, TR, BL and BR (i.e., top left, top right, bottom left and bottom right) and a central portion C of the substrate 20. However, it should be understood by those of skill in the art that the present invention is not limited by the number of locations scanned or by the siting of these locations. For example, the substrate 20 may be scanned at additional locations T, B, L and R midway along sides 24 of the substrate 20 to obtain a plurality of data on the substrate 20. Further, although the present invention is described in relation to a BGA substrate, the skilled person will understand that the present method may be applied to other types of substrates such as, for example, a printed wiring board (PWB).

The substrate scanned data comprises measurements of coplanarities of the solder balls 22. Coplanarity can be measured by techniques such as Shadow-Moiré interferometry and non-contact laser scanning or by using a surface roughness measurement meter. For instance, such laser scanning systems are available from the Semiconductor Equipment Group of Robotic Vision Systems, Inc., of New York, U.S.A. Measurement of solder ball coplanarity is illustrated with reference to FIG. 3. FIG. 3 is an enlarged cross-sectional view of a solder ball 22 of the BGA substrate 20 of FIG. 2. As shown in FIG. 3, coplanarity is measured from an apex A of the solder ball 22 to a seating plane SP of the substrate 20. In one embodiment, the seating plane SP is a plane of best fit through at least three highest apexes amongst the plurality of solder balls 22, and in an alternative embodiment a plane of best global fit through apexes of the plurality of solder balls 22 offset to a highest apex amongst the plurality of solder balls 22.

A warpage characteristic of the substrate 20 is calculated using the scanned data. In this particular example, a warpage characteristic is calculated for each corner TL, TR, BL and BR of the substrate 20 by measuring respective coplanarities of the solder balls 22 in the central portion C and each corner TL, TR, BL and BR of the substrate 20, and then calculating respective average coplanarities for groups of solder balls 22 at the central portion C and each corner TL, TR, BL and BR of the substrate 20. In one embodiment, the groups of solder balls 22 selected for the calculation of the average coplanarities is user specified. A difference between the average coplanarity of the central portion C and the respective average coplanarities for each corner TL, TR, BL and BR of the substrate 20 is calculated thereafter to determine a warpage characteristic for each corner TL, TR, BL and BR of the substrate 20. A location is designated as concave when the difference determination yields a positive value and convex when the difference determination yields a negative value. Although the warpage characteristic is quantified in terms of coplanarity in this particular example, the skilled person will understand that the present invention is not limited to such a means of quantifying the warpage characteristic. The skilled person will understand that the warpage characteristic can also be quantified in terms of percentage bow or percentage twist.

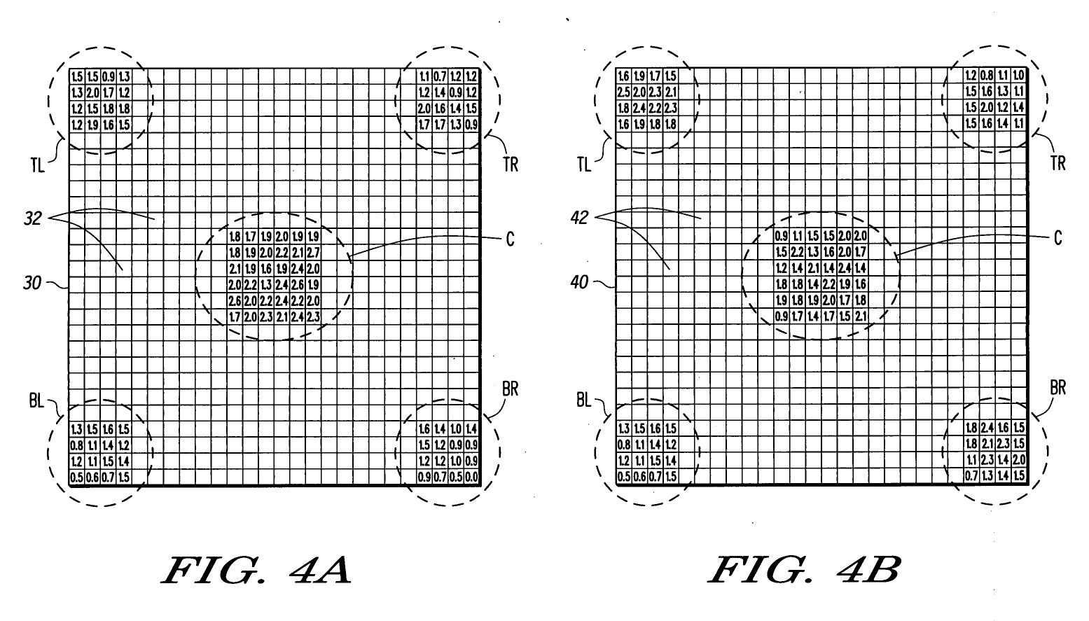

Two examples illustrating the calculation of the warpage characteristics of a plurality of locations on a substrate will now be described with reference to FIGS. 4A and 4B.

Referring first to FIG. 4A, an illustration of a top plan view of a scanned BGA substrate 30 is shown. Each square 32 on the substrate 30 represents a location of a solder ball on the BGA substrate 30. The respective coplanarities of the solder balls in the central portion C and each corner TL, TR, BL and BR of the BGA substrate 30 have been measured and are recorded in the respective squares 32 representing the locations of these solder balls. For example, in the upper left-most square, a value of 1.5 is shown. This value represents the coplanarity of the solder ball in the upper left-most location of the substrate 30. More particularly, the value of SP−A=1.5 mils.

Next, respective average coplanarities C_{C}, C_{TL}, C_{TR}, C_{BL} and C_{BR} for the central portion C and each corner TL, TR, BL and BR of the substrate 30 are calculated by summing the coplanarities of the solder balls in each of these locations and dividing the sum by the total number of solder balls in each of these locations. The calculated respective average coplanarities C_{C}, C_{TL}, C_{TR}, C_{BL} and C_{BR} for the central portion C and each corner TL, TR, BL and BR of the substrate 30 are shown in Table 1.

TABLE 1

| Location (X) | Average Coplanarity (Cₓ) |
|---|---|
| Central portion, C | 2.067 |
| Top left corner, TL | 1.494 |
| Top right corner, TR | 1.313 |
| Bottom left corner, BL | 1.181 |
| Bottom right corner, BR | 1.019 |

Thereafter, differences between the average coplanarity C_{C} of the central portion C and the respective average coplanarities C_{TL}, C_{TR}, C_{BL} and C_{BR} for each corner TL, TR, BL and BR are calculated with the following equations (1) to (4) to determine the respective warpage characteristics W_{TL}, W_{TR}, W_{BL} and W_{BR} for each corner TL, TR, BL and BR of the substrate 30:
W_{TL}=C_{C}−C_{TL} (1)
W_{TR}=C_{C}−C_{TR} (2)
W_{BL}=C_{C}−C_{BL} (3)
W_{BR}=C_{C}−C_{BR} (4)

As previously described, a location is designated as concave when the difference determination yields a positive value and convex when the difference determination yields a negative value. The warpage characteristic W_{TL}, W_{TR}, W_{BL} and W_{BR} and type of warpage of each corner TL, TR, BL and BR of the substrate 30 is shown in Table 2.

TABLE 2

| | Warpage | Type of |
|---|---|---|
| Location (X) | Characteristic (Wₓ) | Warpage |
| Top left corner, TL | 0.573 | Concave |
| Top right corner, TR | 0.754 | Concave |
| Bottom left corner, BL | 0.885 | Concave |
| Bottom right corner, BR | 1.048 | Concave |

Referring next to FIG. 4B, an illustration of a top plan view of another scanned BGA substrate 40 is shown. As in FIG. 4A, each square 42 on the substrate 40 represents a location of a solder ball on the BGA substrate 40. The respective coplanarities of the solder balls in the central portion C and each corner TL, TR, BL and BR of the BGA substrate 40 have been measured and are recorded in the respective squares 42 representing the locations of these solder balls.

A similar series of calculations, as described above with reference to FIG. 4A, to determine the warpage characteristics W_{TL}, W_{TR}, W_{BL} and W_{BR} of each corner TL, TR, BL and BR of the substrate 40 is performed. The results of these calculations are shown in Table 3. Although in the examples shown in FIGS. 4A and 4B, the scanned locations are the four corners and the center, additional locations also may be scanned. Further, although at the corners sixteen points (4×4) have been scanned and at the center thirty-six points (6×6) have been scanned, more points may be scanned at the selected locations.

TABLE 3

| | Average | Warpage | |
|---|---|---|---|
| | Coplanarity | Characteristic | Type of |
| Location (X) | (Cₓ) | (Wₓ) | Warpage |
| Central portion, C | 1.700 | — | — |
| Top left corner, TL | 2.025 | −0.325 | Convex |
| Top right corner, TR | 1.308 | 0.392 | Concave |
| Bottom left corner, BL | 1.575 | 0.125 | Concave |
| Bottom right corner, BR | 1.750 | −0.050 | Convex |

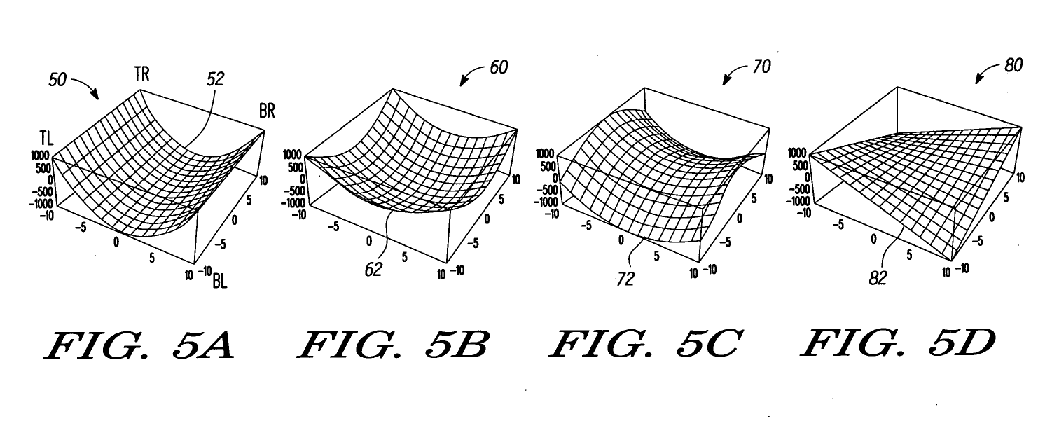

Referring back to FIG. 2, a curvature profile is generated based on the calculated warpage characteristic of the substrate 20. In this particular example, a curvature profile of the substrate 20 is generated based on the warpage characteristic of each corner TL, TR, BL and BR of the substrate 20. The curvature profile is selected from a library of predetermined curvature profiles based on the calculated warpage characteristic for each of the at least four corners TL, TR, BL and BR of the substrate 20. Exemplary curvature profiles stored in the library of predetermined curvature profiles are shown in FIGS. 5A-5D.

Referring now to FIG. 5A, a perspective view of a curvature profile 50 of a substrate 52 having an X or Y direction warpage is shown. The curvature profile 50 is generated when the warpage characteristic W_{TL}, W_{TR}, W_{BL} and W_{BR} of each corner TL, TR, BL and BR of the substrate 52 is positive.

Referring now to FIG. 5B, a perspective view of a curvature profile 60 of a substrate 62 having a central warpage is shown. The curvature profile 60 is generated when the warpage characteristic W_{TL}, W_{TR}, W_{BL} and W_{BR} of each corner TL, TR, BL and BR of the substrate 62 is positive.

Referring now to FIG. 5C, a perspective view of a curvature profile 70 of a substrate 72 having a saddle back warpage is shown. The curvature profile 70 is generated when the warpage characteristic W_{TL}, W_{TR}, W_{BL} and W_{BR} of each corner TL, TR, BL and BR of the substrate 72 is negative.

Referring now to FIG. 5D, a perspective view of a curvature profile 80 of a substrate 82 having a twisted warpage is shown. The curvature profile 80 is generated when the warpage characteristics W_{TL}, W_{TR}, W_{BL} and W_{BR} of the top left and bottom right corners, TL and BR, are positive and that of the top right and bottom left corners, TR and BL, of the substrate 82 are negative.

As previously mentioned, the four curvature profiles 50, 60, 70 and 80 shown in FIGS. 5A-5D, respectively, are merely exemplary curvature profiles stored in a library of predetermined curvature profiles; the skilled person will understand that the curvature profiles stored in the library are not limited to the four (4) curvature profiles 50, 60, 70 and 80 illustrated in FIGS. 5A-5D, respectively. For example, the library may include curvature profiles of substrates having a wavy warpage such as, for example, an m-profile or w-profile curvature. In general, however, a convex curvature profile is generated when all the corners TL, TR, BL and BR of the substrate 20 are negative, while a concave curvature profile is generated when any of the corners TL, TR, BL and BR is positive.

Referring again to FIG. 2, the substrate 20 may be categorized as one of pass and fail based on the generated curvature profile, and the values of the warpage characteristics W_{TL}, W_{TR}, W_{BL} and W_{BR} of each corner TL, TR, BL and BR of the substrate 20. For example, if a substrate is determined to have a concave profile and one of more of the warpage characteristics W_{TL}, W_{TR}, W_{BL} and W_{BR} exceed a predetermined value, then the substrate is rejected because there is a high likelihood that the substrate will fail reliability tests.

As is evident from the foregoing discussion, the present invention provides a method of characterizing warpage of a substrate accurately such that the method can be used to calculate the degree of warpage at a particular location on a substrate, to identify a curvature profile of the substrate, as well as to segregate substrates and to screen out undesirable substrates based on their curvature profiles.

While the preferred embodiments of the invention have been illustrated and described, it will be clear that the invention is not limited to these embodiments only. For instance, the present invention may be applied to any BGA or other semiconductor package measurement or inspection system. Numerous modifications, changes, variations, substitutions and equivalents will be apparent to those skilled in the art without departing from the spirit and scope of the invention as described in the claims.

1. A method of characterizing warpage of a substrate, comprising:
scanning a plurality of predetermined locations on the substrate to obtain substrate scanned data;
calculating a warpage characteristic of the substrate using the scanned data; and
generating a curvature profile based on the calculated warpage characteristic.

2. The method of characterizing warpage of claim 1, further comprising the step of categorizing the substrate as one of pass and fail based on the generated curvature profile.

3. The method of characterizing warpage of claim 1, wherein the plurality of predetermined locations includes at least four corners of the substrate.

4. The method of characterizing warpage of claim 3, wherein the plurality of predetermined locations includes at least a central portion of the substrate.

5. The method of characterizing warpage of claim 4, wherein the substrate has a plurality of solder balls attached to a surface thereof, and wherein the step of calculating a warpage characteristic of the substrate comprises:
calculating an average coplanarity of a group of the solder balls at the central portion; and
calculating an average coplanarity of groups of the solder balls at each of the corner locations.

6. The method of characterizing warpage of claim 5, wherein the step of calculating the warpage characteristic further comprises:
calculating a warpage characteristic for each corner location by determining a difference between the average coplanarity of the center portion and each of the respective average coplanarities of the corner locations.

7. The method of characterizing warpage of claim 6, wherein a location is concave when the difference determination yields a positive value.

8. The method of characterizing warpage of claim 6, wherein a location is convex when the difference determination yields a negative value.

9. The method of characterizing warpage of claim 6, wherein the coplanarity is measured from an apex of one of the plurality of solder balls to a seating plane of the substrate.

10. The method of characterizing warpage of claim 9, wherein the seating plane is a plane of best fit through at least three highest apexes amongst the plurality of solder balls.

11. The method of characterizing warpage of claim 9, wherein the seating plane is a plane of best global fit through apexes of the plurality of solder balls offset to a highest apex amongst the plurality of solder balls.

12. The method of characterizing warpage of claim 1, wherein the substrate is a ball grid array (BGA) substrate having a plurality of solder balls.

13. The method of characterizing warpage of claim 1, wherein the step of generating the curvature profile comprises selecting the curvature profile from a library of predetermined curvature profiles based on the calculated warpage characteristic for each of the at least four corners of the substrate.

14. A method of characterizing warpage of a substrate, comprising:
scanning at least each corner and a central portion of the substrate to obtain substrate scanned data;
calculating a warpage characteristic for each corner of the substrate using the scanned data; and
generating a curvature profile based on the warpage characteristic of each corner of the substrate.

15. The method of characterizing warpage of claim 14, wherein the step of calculating the warpage characteristic comprises:
measuring respective coplanarities of a plurality of points in the central portion and a plurality of points in each corner of the substrate; and
calculating respective average coplanarities for the central portion and for each corner of the substrate.

16. The method of characterizing warpage of claim 15, wherein the step of calculating the warpage characteristic further comprises:
calculating a difference between the average coplanarity of the central portion and the respective average coplanarities for each corner of the substrate.

17. The method of characterizing warpage of claim 16, further comprising the step of categorizing the substrate as one of pass and fail based on the generated curvature profile.

18. A method of characterizing warpage of a BGA substrate having a plurality of solder balls, comprising:
scanning at least each corner and a central portion of the BGA substrate to obtain a plurality of data on the BGA substrate;
measuring respective coplanarities of the solder balls in the central portion and each corner of the BGA substrate;
calculating respective average coplanarities for the central portion and each corner of the BGA substrate;
calculating a difference between the average coplanarity of the central portion and the respective average coplanarities for each corner to determine a warpage characteristic for each corner of the BGA substrate; and
generating a curvature profile based on the warpage characteristic of each corner of the BGA substrate.

19. The method of characterizing warpage of claim 18, further comprising the step of categorizing the substrate as one of pass and fail based on the generated curvature profile.

20. The method of characterizing warpage of claim 19, wherein the step of generating the curvature profile comprises selecting the curvature profile from a library of predetermined curvature profiles based on the calculated warpage characteristic for each of the at least four corners of the substrate.
